(19) United States
(12) Patent Application Publication
(10) Pub. No.: US 2008/0172443 A1
(43) Pub. Date: Jul. 17, 2008

(54) Automatic Internet Connection Device

(76) Inventors: Colette Abigael Azulay Roger, Cannes (FR); Julien Roger, Antibes (FR)

Correspondence Address: BACHMAN & LAPOINTE, P.C., 900 CHAPEL STREET, SUITE 1201, NEW HAVEN, CT, 06510, US

(21) Appl. No.: 11/794,829

(22) PCT Filed: Jan. 6, 2006
(86) PCT No.: PCT/FR06/00023

§ 371 Date: Nov. 28, 2007

(30) Foreign Application Priority Data
Jan. 6, 2005 (FR) 0500121

(51) Int. Cl. G06F 15/16

(52) U.S. Cl. 709/201

(57) ABSTRACT

An automatic connection device in a data transmission system comprises the Internet, several local networks which are connected to the Internet, a first host computer being used by a first user and a second host computer being used by a second user connected to the Internet. The device further has a hardware connection mechanism, such as a USB port which is intended to be connected to a corresponding hardware connection of the first host computer, and a software connection which mechanism automatically connects the first host computer to one of the local networks once the hardware connection mechanism of the device has been physically connected to the corresponding hardware connection mechanism of the first host computer, thereby enabling the exchange of data between the first host computer and the second host computer.

### FIELD OF THE INVENTION

This invention relates to data transmission systems wherein a user with a host computer wishes to exchange data with another user having a host computer connected to the Internet, and relates in particular to an automatic connection device to the Internet in such a system.

### STATE OF THE PRIOR ART

Today, when a mobile user of the Internet wishes to exchange data with another user, modern techniques allow him to implement a certain number of means. Among these, the cellular telephone represents the advantage of taking up little space and to be able to access the Internet from almost any location. Indeed, the cellular telephone is becoming more and more sophisticated and is now equipped with multimedia features such as a camera able to record photographs as well as film.

Consequently, the cellular telephone must have a tool that is a specific software allowing to manage the contents of each feature, regardless of whether this content is an SMS, an EMS, a ring tone, a melody, a contact name and the number, a complete contact (last name, first name, address, email, cell phone number, fixed-line number, work number) a film, an image, etc. This tool is sometimes provided by the cell phone manufacturer. But the tools all differ from one another and even, within a same brand, differ from one model to another.

The user benefiting from one of these tools (often delivered with the cell phone) has great difficulty, when he changes cellular telephones, to continue to use it. It is often totally impossible for him to continue with the same software and he must change the tool with all of the incompatibilities and constraints pertaining to the operation of transferring his data that this entails.

Operating systems, many and constantly changing, are also a source of issues for users of these tools who must constantly make sure that their drivers, tool and “firmware” versions are up to date, and this, in order to guarantee the use of all of the features provided by the tool.

Another solution consists in using memory devices, also called USB devices or memory sticks that constitute, due to their increasing capacity, an ideal solution for transporting one or more elements, whether or not multimedia, from one computer to another, or even, for the most advanced users, from one place to another. This increasing use of memories of this type that are easily stored in a pocket, are pushing manufacturers of cell phones to include larger memory capacities in some of their models and to equip them with means of communication that are more and more evolved in order to communicate with the computer.

However, the mobile user wants to be able to be reached in all circumstances. The fact that he connects his cell phone to his PC for operations concerning the synchronization and management of the content of his cell phone, must not prevent him from receiving a call without complications. Furthermore the cell phone itself must not be mobilized by the software so that the user, if he wishes, can use it for a simple call at any time.

A solution has been proposed by the Handspring company which commercialized a personal assistant (PDA) that incorporates telephone and modem functions in addition to the memory elements that are already available in the non-communicating models of these devices. This highly user-friendly solution remains expensive and often represents a duplicate function in relation to the laptop computer of which the mobile person is very often equipped. Users thus hesitate to make the leap and acquire such PDAs.

There currently is therefore a need for a means that offers the mobile user with a computer to have the combined advantages of a USB memory stick for data storage, a high-speed modem in order to communicate using a telephone network and a sophistical cellular telephone, while only having to connect to the telephone network.

### SUMMARY OF THE INVENTION

That is why the purpose of the invention is to provide a device allowing any user with a host computer to automatically connect to a local network, whether this is a cellular network, a WiFi network or a LAN network, with the purpose of exchanging data with another host computer connected to the Internet.

The object of the invention is therefore an automatic connection device comprised of a box in a data transmission system including the Internet or equivalent network, several local networks connected to the Internet, a first host computer being used by a first user and a second host computer being used by a second user connected to the Internet, with the first user wishing to exchange data between the first host computer that he is using and the second host computer connected to the Internet. The box comprises a hardware connection means such as a USB port which is intended to be connected to a corresponding hardware connection means of the first host computer, and a software connection means which automatically connects the first host computer to a local network through the intermediary of a local network interface (LNI) device such as an interface card, once the hardware connection means of the device has been physically connected to the corresponding hardware connection means of the first host computer, thereby enabling the exchange of data between the first host computer and the second host computer. The software connection means include a declaration software which allows the box to be recognized as a CD ROM by the operating system of the host computer of the first user when the hardware connection means (USB port) is connected to the corresponding hardware connection means of the first computer. A self-executable “autorun.inf” file is immediately executed by the operating system of the host computer so as to install the software connection means and the drivers or utility software needed for the connection.

### BRIEF DESCRIPTION OF THE DRAWINGS

The purposes, objects and characteristics of the invention shall become clearer when reading the following description and in reference to the drawings wherein:

FIG. 1 is a block diagram representing a data transmission system wherein a devise according to the invention is implemented;

FIGS. 2A and 2B representing respectively a first and a second embodiment of the box comprising the device according to the invention; and

FIGS. 3A, 3B and 3C representing together a flowchart of the steps in the operating method of the device according to the invention.

### DETAILED DISCLOSURE OF THE PREFERRED EMBODIMENTS

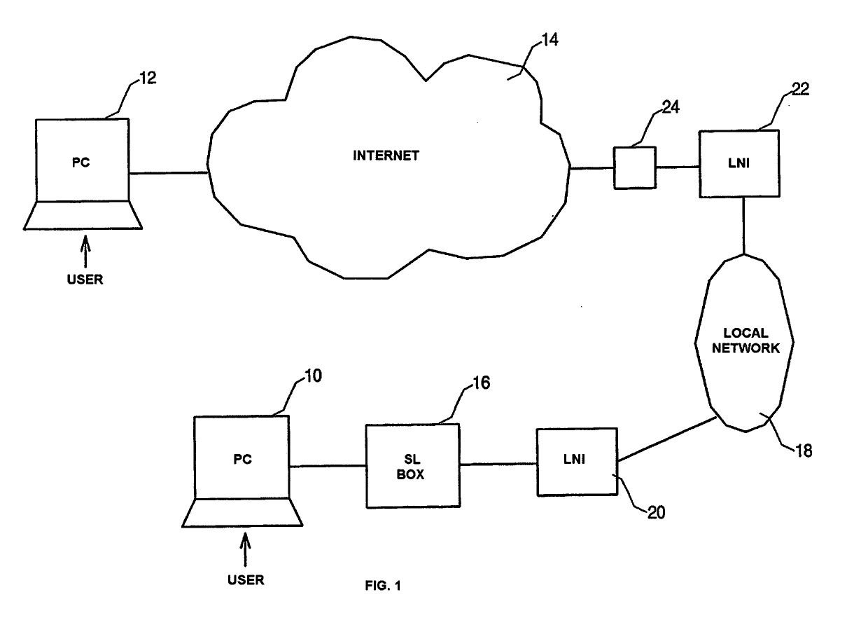

Reference is first made to FIG. 1 which shows a system wherein the device according to the invention is implemented. It is supposed that a first user of the mobile type is using a host computer 10 whereby which he wants to exchange data with a second user also using a host computer 12 connected to the Internet 14. The first user could be a commercial agent outside of his company wishing to communicate with another person located in the company.

The first user has at his disposition a device according to the invention which is present in the form of a box 16 called “SeamlessKey” (SL). As we shall see in what follows, this box includes a male USB port which must be connected to a female USB port of computer 10 in order to be used.

As disclosed below, SL box 16 includes connection software intended to automatically connect to a local network 18 by the intermediary of a local network interface (LNI) device 20 such as an interface card. Local network 18 is connected by the intermediary of another local network interface device 22 such as an interface card, and a gateway 24 to the Internet. As we shall see in what follows, LNI device 20 can be incorporated into box 16.

The simple physical connection of SL box 16 to computer 10 allows the first user to be automatically coupled to the Internet 14 and thereby be able to exchange data with the second computer immediately with no intervention on the part of the user. The connection to the USB port of the computer allows the operating system of the computer to automatically start the application(s) present in the device when the USB port is inserted.

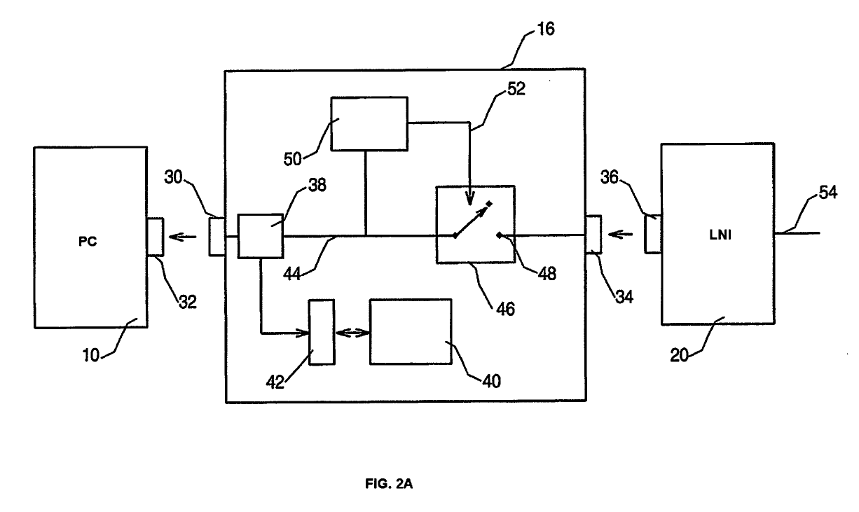

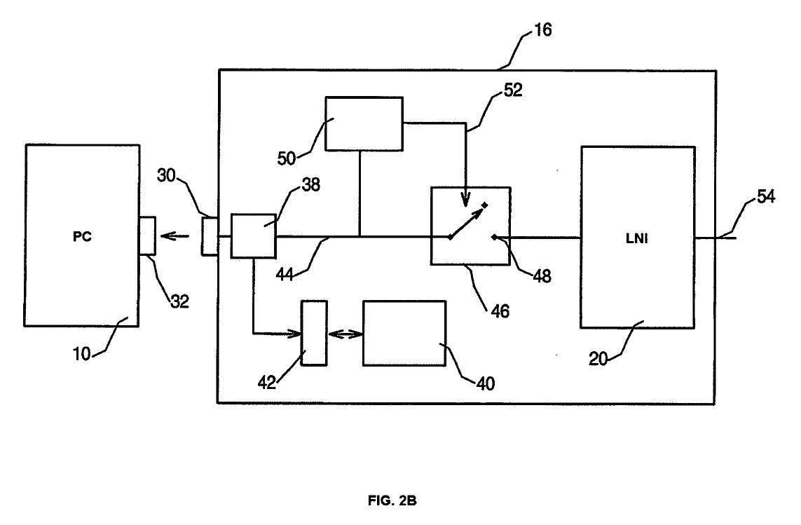

In a first embodiment shown in FIG. 2A, box 16 includes a male USB port 30 which plugs into a female USB port 32 of computer 10, and on the other side, a female port 34 in which is inserted male USB port 36 of LNI device 20. The connection of the latter takes place at the same time or just before the connection of box 16 to host computer 10. The LNI device 20 is connected via its outgoing line 54 to local network 18 (see FIG. 1). Note that the USB ports could be replaced by any other connection means that fulfill the same functions as the USB ports.

Box 16 includes a concentrator 38 (known as a “hub”) which make visible the peripheral devices that are coupled with it. Auxiliary memory 40 of high capacity is directly connected to the concentrator 38 via the intermediary of the memory controller 42. Auxiliary memory 40 of high capacity contains the utility software (drivers) coupled to LNI device 20 as well as the user data such as the configuration data and, in general, all of the parameters that are necessary to operate the box. Note that auxiliary memory 40 can contain utility software and associated data.

Outgoing line 44 of concentrator 38 is the incoming line of a switch 46 at a single output position 48. When idle, the switch output is disconnected, i.e. the link between concentrator 38 and LNI device 20 is not established.

An activation means 50 permanently connected to line 44 controls the activation of switch 46 by an output command 52 when it receives an instruction requesting that it proceed with activation. In this case, switch 46 is positioned to position 48, which renders LNI device 20 visible to computer 10.

According to a second embodiment shown in FIG. 2B, box 16 includes the same elements as the box shown in FIG. 2A except that LNI device 20 is incorporated into the box. In this case, box 16 must be connected by its outgoing line 54 to local network 18 (see FIG. 1), either at the same time, or just before the connection of box 16 to host computer 10.

The software means located in auxiliary memory 40 of box 16 automatically detects and recognizes the operating environment wherein is located the box. This includes the operating system of the computer, the link that couples it to other communications entities when this is the case, the operating language, the telecommunications network used and the available local network interface cards.

Moreover, SL box 16 preferably includes a software tool allowing it to automatically connect to one (local network 18) of several possible local networks. So, local network 18 can be a LAN or a wireless network. In the second case, the local network can be a WiFi network or a GPRS/GSM, EDGE, CDMA or UMTS cellular telephone network. Note that in the case of a cellular network, LNI device 20 (as well as device 22) is a wireless modem therefore without a physical outgoing line 54.

Note that remote updating of the box can be provided, allowing the configuration and parameters of the box to be modified. This allows a system administrator to be able to change the behavior of the box at will. By sending various configuration and parameter files, the system administrator can take action in such a way that the box accepts a wireless connection from only one operator or that a single determined LNI device (20) be accepted for establishing the connection.

The system administrator can also determine if the updates are to take place and if so, what updates are allowed.

Auxiliary memory 40 of box 16 of a capacity of at least 128 megabytes contains the following mobile content management features or multimedia functions: SMS and EMS management, MMS management, ring tone and melody management, video and fixed image management and management of all other files.

Note that SL box 16 can be identified uniquely in the world thanks to an IMEI (International Mobile Equipment Identifier) number. This identification allows, among other things, targeted services to be set up. This is accomplished by associating the box with the user data of its owner, data provided by the user himself with his cellular telephone or WiFi service provider and used with his approval.

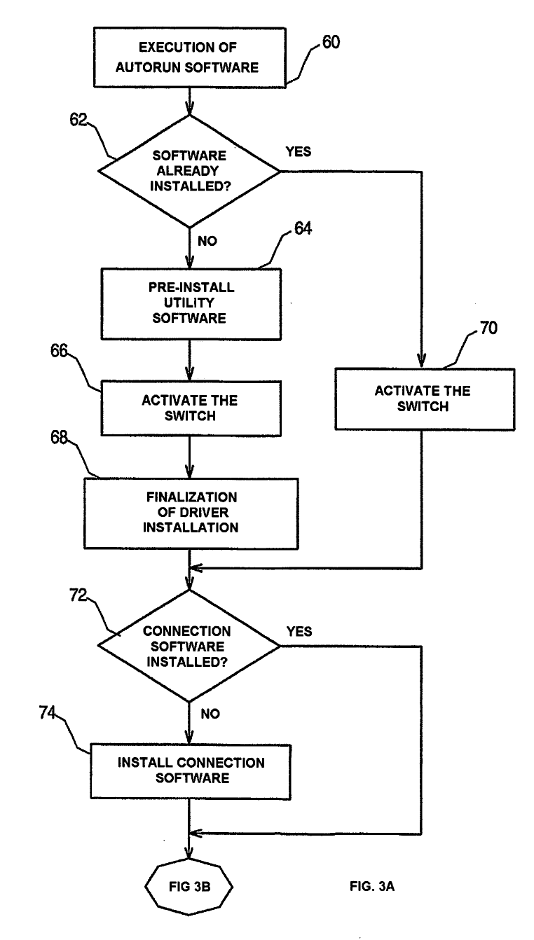

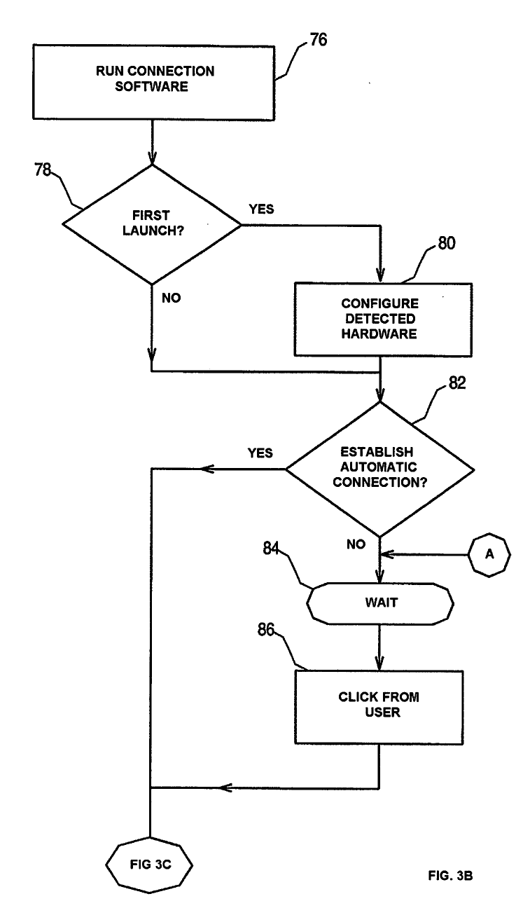

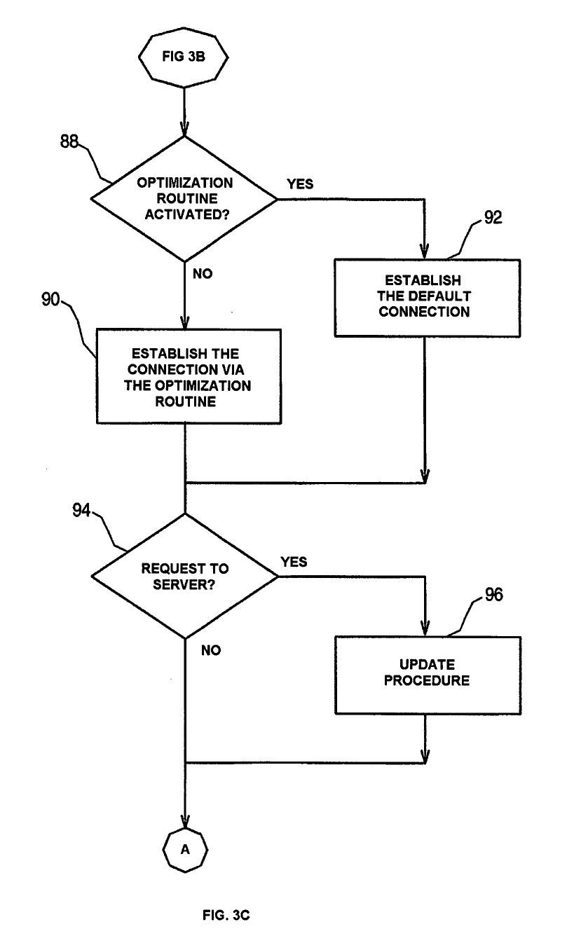

The steps shown in the flowchart in FIGS. 3A, 3B and 3C then take place. When the USB port of SL box 16 is inserted into computer 10, one of the essential characteristics of the invention is that the box contains a declaration (or identification) software which allows it to be recognized by the operating system of the computer as a CD ROM. Immediately, the operating system looks for a self-executing “autorun.inf” file in the SL box and executes (step 60) the instructions that it contains, i.e. the installation instructions of the connection software, various drivers and in general all of the other functions contained in the SL box.

At this stage, the procedure differs according to whether or not the SL box is installed for the first time. The procedure determines if the utility software is already installed (step 62). If it is a first installation, the operating system of the computer proceeds with the pre-installation of the drivers or utility software stored in auxiliary memory 40 of the box (step 64).

After pre-installation, an instruction sent via activation means 50 of the box 16 causes activation of switch 46 (step 66). At this stage, LNI device 20 is connected to computer 10 by switch 46. The operating system of the computer can then finalize the installation of the drivers or utility software (step 68). Note that, if the utility software is already installed, the procedure proceeds with activating switch 46 (step 70) and moves directly to the following steps.

Then the operating system verifies that the connection software is installed (step 72). If this is not the case, i.e. this is a first installation, an uninstallation or a false manipulation, then the operating system installs the connection software (step 74) and moves on to the following steps shown in FIG. 3B. However, for the second use of the box or the following installations, and the connection software had not been modified or deleted, it has already been installed and the procedure directly moves on to the following steps in FIG. 3B.

Firstly, the connection software is run (step 76). It is determined if it is a question of a first run (step 78). If this is the case, the operating system of the computer detects, initializes and configures the connected hardware (step 80). After these operations have taken place or if it is not a question of a first run, the connection software immediately and automatically establishes the connection without any intervention on the part of the user. For this, the program determines if the communications mode is the automatic connection mode (step 82).

It must be noted that the normal and default connection mode is the automatic connection mode. In the normal case, the program scans all of the computer's authorized connection ports, i.e. the serial ports, USB ports, Infrared links and Bluetooth links, in order to find on which one SL box 16 is connected. The connection profile is then instantiated according to the connection that is found. Then the SIM card contained in SL box 16 is read in order to determine the telephone operator with whom the user has a subscription.

The program searches, and will subsequently use in order to establish the connection, the profile corresponding to the user. This “connection profile” groups together the parameters and settings that are known in advance and which are specific to each type of network, to each user and which characterize the connection.

The user can however modify the connection mode so that the SL box 16 does not connect automatically when it is inserted into the USB port of the computer. In this case, the program waits for a click from the user (step 84). The user can then, by clicking (step 86) establish the connection or run a shortcut. The shortcut establishes the connection and runs the application associated with the shortcut. This latter manual shortcut principle is called “OneClick”. The connection is established using, as with the default “all automatic” mode, the connection profile that is adequate to the operator.

This connection profile concept allows the user to not have any key entry or any manual settings whatsoever to perform. Indeed, without this profile system, the user would have to proceed with the various connection settings.

Whether the command is triggered by the user clicking on a shortcut or by the connection being automatic, the program then determines whether or not a specific routine for optimizing the connection choice is activated (step 88). If this is the case, the connection is established using the “SmartConnect” routine which belongs to the requestor (step 90).

The specific “SmartConnect” routine makes it possible, when the connection is being established, to automatically select the best connection while at the same time ensuring an LCR (Least Cost Routing) function. The best connection is the network connection with the best transfer rate (or best speed). If this network is not available or cannot be accessed from the place where the user is located and/or at the time of the establishment, then the network with the best speed is used instead. If the use of the latter is also impossible, then the network with the third best speed is used instead and so on until all of the resources have been attempted. Classification can be established via a list which has in order of connection priority the various networks to which the user, in terms of the characteristics of his subscription, is allowed to connect to.

If the SmartConnect software is not activated, the default connection is established (step 92). Note that this connection can be established because the user has clicked on a shortcut designating an application, in which case the link specified by the shortcut is executed as soon as the connection is established, or because the user has clicked on the “connect” button, which allows the connection to be made without launching an application.

According to a characteristic of the invention, each time a connection is established for the exchange of data, SL box 16 consults an update server by sending it a request according to the client-server principle (step 94). The update procedure is then triggered (step 96). The request is processed by the server which informs the SL box of the versions of the software elements that it has. The SL box checks if the versions sent by the server are higher than the versions that it has. If the versions on the server are higher than those of which the SL box is currently equipped, the latter informs the user of the availability of updates. At this stage, nothing is performed by the SL box in order to allow the user to choose whether or not to download the updates that are available. So the user's data rate plan (or his subscription regardless of the type) is not used for the purpose of updates that he may not want. If the user accepts the updates, the SL box sends the corresponding request to the server so that the server sends the required updates (PUSH method).

Of course, the default behavior may be different according to the user's wishes and can be modified by the latter according to his preferences. So, the downloading of updates can be automatic as soon as they are available without the user having to validate each one that is available. Or, the check for the availability of updates can also be blocked.

However, in order to allow the operator to continue to send updates concerning its services or messages of an advertising nature, where applicable, the SL box signals its presence to the server each time it connects. This is accomplished by sending a request that provides the server with the IP address where the SL box can be reached. By using a personalized channel (IP), the server can then send to the SL box the advertising pages or information programmed by the operator.

Note that after any updating step using the server, the software waits for other clicks from the user for several reasons: because the connection failed to be established, because the connection, once established, was interrupted, or because the user wants to access the memory or send an SMS. In all of these cases, the process loops (A) to the waiting stage (step 84) in FIG. 3B.

In addition to the automatic establishment of a connection for data exchange, the user can perform a certain number of actions either after the immediate establishment of the connection, or when he clicks on the appropriate button. These actions are: sending and receiving SMS and EMS messages, managing contacts, establishing voice calls, and freely accessing the memory of the SL box.

1. Sending and receiving SMS and EMS messages.

A button allows the user to access the window for keying and reading SMS and EMS messages. From this window, the user can edit the text of one or more SMS or EMS messages, designate the addressee(s) and send the SMS or EMS message(s). He can also transfer SMS or EMS messages received, with or without making modifications. The SMS and EMS messages can be sent to a list of addressees. In the same window, the SMS and EMS messages received are displayed and can be consulted and read by the user.

2. Managing and synchronizing contacts

The user can manage his contacts or synchronize them with contact management software such as Outlook Express from Microsoft. A button allows him to access the contact management window. From this window, the user can edit, add, delete and modify contacts and synchronize them with his normal contact manager. He can also transfer these contacts from the SL box to the computer or from the computer to the SL box.

3. Voice calls

The user, by clicking on the corresponding button, is taken to a window where he can enter the telephone number to be called. The addressee for the call can also be selected in the contact list. Likewise, the user can accept or refuse an incoming call via the intermediary of this window.

4. Free access to the memory

Access to the memory is accomplished via the normal interface provided by the operating system. The user can store here any item that can be managed by his computer and the size of which allows it to be stored in the memory of the SL box. In this memory of which the capacity can be 128 megabytes or more, a certain number of megabytes are reserved in as a write-once-read-many zone (protected read-only zone) in order to accommodate the applications, drivers and elements that are required to operate the SL box.

In order to preserve the work space made available to the user on the computer (10), the latter has software that makes it possible to implement a “cleaning” function. For this, the program installs an icon on the desktop of computer (10) at the time of connection to the box. When the cleaning function is activated by clicking on this icon, the user very easily can and very quickly uninstall the files and software that had been installed during the phases of pre-installation of utility software and updates, of finalization of utility software installation and of the installation of the connection software. In this way, absolutely no traces of the operations performed by the user are left, especially the connection of the box to computer 10.

According to an alternative embodiment, automatic uninstallation can be triggered manually by the user, by disconnecting the box from the computer. In this way, the user has no need to click on an icon.

1-14. (canceled)

15. Automatic connection device comprising:
a box in a data transmission system including the Internet or an equivalent network, several local networks connected to said Internet, a first host computer being used by a first user and a second host computer being used by a second user connected to said Internet, said first user exchanging data between said first host computer and said second host computer connected to the Internet,
said box including a hardware connection means connected to a corresponding hardware connection means of said first host computer, and a software connection means which automatically connects said first host computer to one of said local networks through a local network interface (LNI) device once said hardware connection means of the box has been physically connected to said corresponding hardware connection means of said first host computer, thereby enabling an exchange of data between said first host computer and said second host computer, with said software connection means including a declaration software which allows said box to be recognized as a CD ROM by an operating system of the first host computer of said first user when said hardware connection means is connected to said corresponding hardware connection means of said first host computer, and a self-executable “autorun.inf” file that is immediately executed by the operating system of said first host computer so as to install said software connection means and at least one of drivers and utility software needed for the connection.

16. Device according to claim 15, wherein said software connection means include a connection software intended to establish the connection immediately and automatically without intervention on the part of the user, said connection software being installed by said operating system of said first host computer during a first installation of said software connection means.

17. Device according to claim 16, wherein said box includes a switch including a single output position connected to said LNI device and an incoming line linked to said hardware connection means, and an activation means permanently connected to said incoming line, said activation means controlling the activation of said switch on said output position when receiving an instruction from said operating system.

18. Device according to claim 17, wherein said LNI device is an independent device placed between said box and said local networks.

19. Device according to claim 17, wherein said LNI device is incorporated into said box.

20. Device according to claim 17, wherein said operating system of said first computer configures the connected box when said software connection means are run before said connection software automatically establishes the connection.

21. Device according to claim 15, wherein said software connection means includes a specific optimization routine which makes it possible, when the connection is established, to automatically choose a best connection by ensuring at the same time an LCR function, with the best connection being the connection to the one of said local networks with a best transfer rate speed.

22. Device according to claim 15, wherein said software connection means includes a specific software used when the connection does not take place automatically and which allows, when said first user performs a single click on a shortcut icon of a determined application to run a connection software that performs an establishment of the connection and to run said application by using the established connection.

23. Device according to claim 16, wherein said connection software uses a connection profile that characterizes an established connection and which groups together parameters and settings known in advance and which are specific to each of said local networks and to each user, which thereby avoids the respective user having to perform manual key entry or settings.

24. Device according to claim 15, wherein said software connection means are intended to consult an update server by sending the update server a request, so as to run an update procedure of the software means of the device when versions that the said server has are more recent that versions of the device.

25. Device according to claim 15, further including means for said first user to perform a certain number of actions after the connection has been established, said actions including sending and receiving SMS and EMS messages, managing contacts, establishing voice calls, and freely accessing a memory of the device.

26. Device according to claim 15, wherein said local networks are a LAN.

27. Device according to claim 15, wherein said local networks are each a wireless network selected from the group consisting of a WiFi network, and a cellular telephone network of the GPRS/GSM, EDGE, CDMA or UMTS type.

28. Device according to claim 15, wherein an icon is installed on a desktop of said first host computer at the time of the connection of said box in a such a way that, by clicking on said icon, a cleaning function is implemented and makes it possible to uninstall the software and files that had been installed by said software connection means.

29. Device according to claim 15, wherein a cleaning function is implemented in said first host computer when said box is disconnected from said computer and makes it possible to uninstall the software and files that had been installed by said software connection means.
